(19) United States
(12) Patent Application Publication
(10) Pub. No.: US 2024/0112659 A1
(43) Pub. Date: Apr. 4, 2024

(54) KEYBOARD DEVICE FOR KEYBOARD INSTRUMENT

(71) Applicant: KABUSHIKI KAISHA KAWAI GAKKI SEISAKUSHO, Hamamatsu-shi (JP)

(72) Inventor: Satoshi KITO, Hamamatsu-shi (JP)

(21) Appl. No.: 18/478,533

(22) Filed: Sep. 29, 2023

(30) Foreign Application Priority Data
Oct. 4, 2022 (JP) 2022-159932

(51) Int. Cl. G10H 1/34

(52) U.S. Cl. CPC G10H 1/346; G10H 2220/221; G10H 2220/265

(57) ABSTRACT

A keyboard device for a keyboard instrument includes a keyboard chassis made of synthetic resin and having a stopper support portion for supporting a stopper extending in a left-right direction. Keys extend in a front-rear direction, and each key is pivotally moved downward by depression thereof and pivotally moves upward by release thereof to move into contact with the stopper from below via a contact portion thereof protruding forward, thereby having further upward pivotal movement thereof blocked. The stopper support portion includes a plate-like erected portion extending in the left-right direction along the entirety of the keys, and a stopper mounting portion having the stopper mounted on a lower surface thereof. The keyboard chassis further includes plate-like ribs erected on a front surface of the erected portion such that the ribs are associated with corresponding ones of the contact portions of the keys, respectively.

### BACKGROUND OF THE INVENTION

### Field of the Invention

The present invention relates to a keyboard device which is applied to a keyboard instrument, such as an electronic piano, and includes a keyboard chassis made of synthetic resin.

### Description of the Related Art

Conventionally, as this kind of a keyboard device for a keyboard instrument, there has been known, for example, one disclosed in Japanese Laid-Open Patent Publication (Kokai) No. 2000-56766. This keyboard device includes a keyboard chassis formed as a resin molded article having a predetermined shape, a plurality of keys vertically pivotally supported on the keyboard chassis and formed by white keys and black keys, and a plurality of hammers pivotally mounted on the keyboard chassis on a key-by-key basis. In the keyboard device, when a key is depressed, the key is pivotally moved downward, and a hammer associated therewith is pivotally moved in a predetermined direction, whereby a predetermined touch weight is imparted to the key being depressed. Further, when the key is released, the hammer pivotally moves in a direction opposite to the predetermined direction, to thereby push the key upward to pivotally move the same upward along therewith. In this case, a stopper portion of the key moves into contact with an upper limit stopper member mounted on the keyboard chassis from below, whereby further upward pivotal movement of the key is blocked, and the key returns to its original position where it was before key depression.

The above-mentioned upper limit stopper member is formed of a belt-like felt and is disposed such that it extends in a left-right direction along the entirety of the plurality of keys disposed in a side-by-side arrangement in the left-right direction. Further, the keyboard chassis described above includes six channel-shaped portions each extending in the left-right direction and open either forward, upward or downward in side view. These channel-shaped portions are formed continuous with each other in a front-rear direction. In addition, in the keyboard chassis, each channel-shaped portion is provided with a plurality of rib plates disposed with a spacing therebetween in the left-right direction, and is reinforced by the rib plates.

Although the above-described keyboard chassis has each channel-shaped portion appropriately provided with the rib plates, since each rib plate is disposed such that it is located every two or three keys and between each adjacent ones of the keys, the rigidity of some part of the keyboard chassis becomes insufficient. More specifically, as described above, in the keyboard device, when the key having been depressed is released, the key pivotally moves upward while being pushed up by the pivotally moving hammer, so that the stopper portion of the key moves into contact with the stopper member relatively strongly. For this reason, impact or vibration caused by the contact is transmitted to a portion of the keyboard chassis, which is contacted by the stopper portion of the key, and if the rigidity of the portion is not sufficient, there is a fear that the keyboard chassis is broken. Of course, the rigidity of the keyboard chassis can be increased by increasing the thickness of a portion where the stopper member is mounted and thicknesses of components therearound. In this case, however, the weight of the keyboard chassis is increased by the increased thicknesses, which makes the keyboard instrument itself heavier.

### SUMMARY OF THE INVENTION

It is an object of the present invention to provide a keyboard device for a keyboard instrument, which is increased in the rigidity of a keyboard chassis while ensuring reduction of the weight of the keyboard chassis.

To attain the above object, the present invention provides a keyboard device for a keyboard instrument, including a keyboard chassis made of synthetic resin and having a stopper support portion that supports a stopper extending in a left-right direction, and a plurality of keys each extending in a front-rear direction and configured such that each key is pivotally moved downward in accordance with depression of the key, and in accordance with release of the key having been depressed, pivotally moves upward into contact with the stopper from below via a contact portion protruding from a lower portion of a front end of the key in a front-rear direction, to thereby have upward pivotal movement of the key blocked, the plurality of keys being disposed on a top of the keyboard chassis in a side-by-side arrangement in the left-right direction, wherein the stopper support portion includes a plate-like erected portion extending in the left-right direction along the entirety of the plurality of keys in a state erected at a location forward of or below the plurality of keys, and a stopper mounting portion formed in a plate shape protruding from an upper end of the erected portion in the front-rear direction, and having the stopper mounted on a lower surface thereof, and wherein the keyboard chassis further includes a plurality of plate-like ribs erected on a front surface or a rear surface of the erected portion, such that the ribs are associated with corresponding ones of the contact portions of the plurality of keys, respectively.

According to this construction, the keyboard chassis made of synthetic resin has the stopper support portion for supporting the stopper that extends in the left-right direction. Further, the plurality of keys each extending in the front-rear direction are disposed on the top of the keyboard chassis in a side-by-side arrangement in the left-right direction. Each key is pivotally moved downward in accordance with depression thereof and pivotally moves upward in accordance with release of the depressed key into contact with the stopper from below via the contact portion protruding from the lower portion of the front end of the key in the front-rear direction. With this, further pivotal movement of the key is blocked.

Further, the stopper support portion of the keyboard chassis includes the plate-like erected portion erected at the location forward of or below the keys and extending in the left-right direction, and the plate-like stopper mounting portion protruding from the upper end of the erected portion in the front-rear direction. The stopper is mounted on the lower surface of the stopper mounting portion. As described above, when the key having been depressed is released, the contact portion of the key moves into contact with the stopper from below. In this case, since the plate-like ribs are erected on the front surface or the rear surface of the erected portion of the keyboard chassis such that the ribs are associated with corresponding ones of the contact portions of the plurality of keys, respectively, it is possible to directly and efficiently reinforce a portion of the keyboard chassis, which is contacted by the contact portion of each key. As described above, in the keyboard chassis, the ribs are formed at locations corresponding to the associated contact portions of the plurality of keys, so that it is possible to increase the rigidity of a portion of the keyboard chassis, which is liable to receive impact or vibration caused by release of each depressed key, while ensuring reduction of the weight of the keyboard chassis.

Preferably, the stopper support portion further includes a horizontally protruding portion horizontally protruding from the front surface or the rear surface of the erected portion and extending in the left-right direction along the entirety of the erected portion, and each of the plurality of ribs is continuous with the erected portion and the horizontally protruding portion and is provided at a corner between the erected portion and the horizontally protruding portion.

According to the construction of this preferred embodiment, the stopper support portion includes the horizontally protruding portion horizontally protruding from the front surface or the rear surface of the erected portion and extending in the left-right direction, and each of the ribs is provided at the corner between the erected portion and the horizontally protruding portion. This structure makes it possible to further increase the rigidity of a portion of the keyboard chassis, where each rib is provided.

Preferably, the stopper mounting portion is formed by a plurality of stopper mounting portions which are associated with the plurality of keys, respectively, and are disposed with a spacing therebetween along a longitudinal direction of the erected portion.

According to the construction of this preferred embodiment, portions of the stopper, associated with the contact portions of the respective keys, can be securely mounted on associated ones of the stopper mounting portions. Further, compared with a case in which the stopper mounting portions are formed as a continuous member extending along the longitudinal direction of the erected portion, it is possible to reduce the amount of synthetic resin required for molding the keyboard chassis and relatively easily perform the molding thereof.

Preferably, the plurality of keys are formed by white keys and black keys, and each of the plurality of ribs is formed at a location corresponding to an associated one of the black keys.

According to the construction of this preferred embodiment, in the keyboard device including the plurality of keys formed by the white keys and the black keys, since each of the plurality of ribs is formed at the location corresponding to the associated one of the black keys, it is possible to appropriately increase the rigidity of a portion of the keyboard chassis, which is contacted by the contact portion of the black key.

The above and other objects, features, and advantages of the present invention will become more apparent from the following detailed description taken in conjunction with the accompanying drawings.

### BRIEF DESCRIPTION OF THE DRAWINGS

FIGS. 1A and 1B are perspective views of a part (one octave section) of a keyboard device for an electronic piano to which the present invention is applied, in which FIG. 1A shows the appearance of the keyboard device and FIG. 1B shows a state in which keys other than a white key and a black key at a left end of the keyboard device are omitted;

FIG. 2 is a perspective view of the keyboard device shown in FIG. 1B in a state in which the white key and the black key are removed, together with respective key support mechanisms therefor, from a keyboard chassis;

FIG. 3A is a plan view of the keyboard device shown in FIG. 1B and FIG. 3B is a cross-sectional view taken along line A-A of FIG. 3A;

FIGS. 4A and 4B are perspective views of the white key and the key support mechanism therefor, in which FIG. 4A shows the white key and the key support mechanism in a connected state and FIG. 4B shows the white key and the key support mechanism in an exploded state;

FIGS. 5A and 5B are perspective views of the black key and the key support mechanism therefor, in which FIG. 5A shows the black key and the key support mechanism in a connected state and FIG. 5B shows the black key and the key support mechanism in an exploded state;

FIGS. 6A and 6B are views useful in explaining operation of the white key in the keyboard device, in which FIG. 6A shows a key-released state and FIG. 6B shows a key-depressed state;

FIGS. 7A and 7B are views useful in explaining operation of the black key in the keyboard device, in which FIG. 7A shows a key-released state and FIG. 7B shows a key-depressed state;

FIGS. 8A and 8B are diagrams of a chassis body of the keyboard chassis, in which FIG. 8A is a perspective view and FIG. 8B is a plan view; and

FIGS. 9A and 9B are views corresponding to FIGS. 7A and 7B, respectively, which show a stopper support portion for supporting a key upper limit stopper for the black key, a reinforcement rib, and components therearound, on an enlarged scale.

### DETAILED DESCRIPTION OF PREFERRED EMBODIMENTS

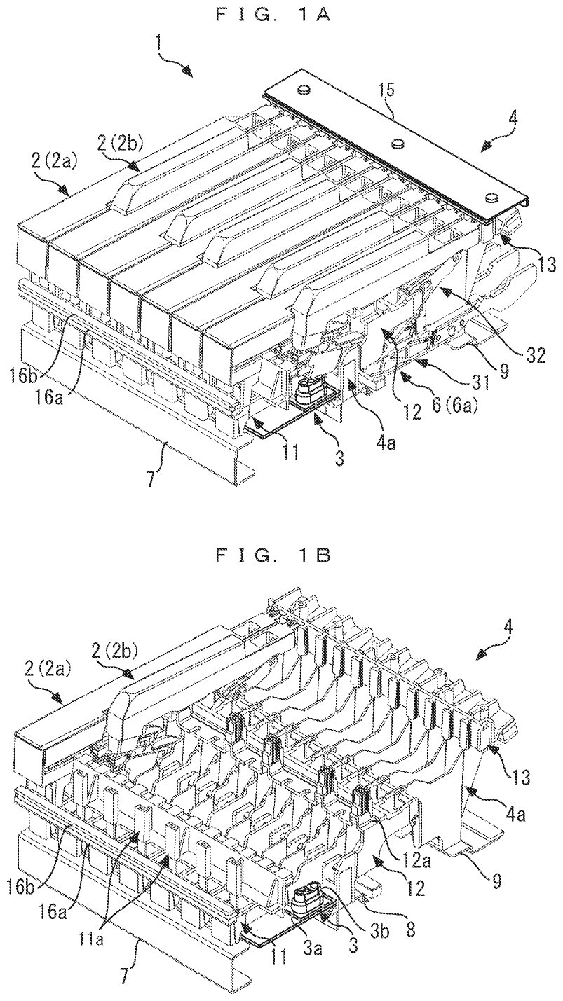

The present invention will now be described in detail with reference to the drawings showing preferred embodiments thereof. FIG. 1A shows only one octave section of a keyboard device 1 for an electronic piano to which the present invention is applied. Note that in the following, a description will be first given of the basic construction of the keyboard device 1 and operation thereof, and then of an essential part of the present invention.

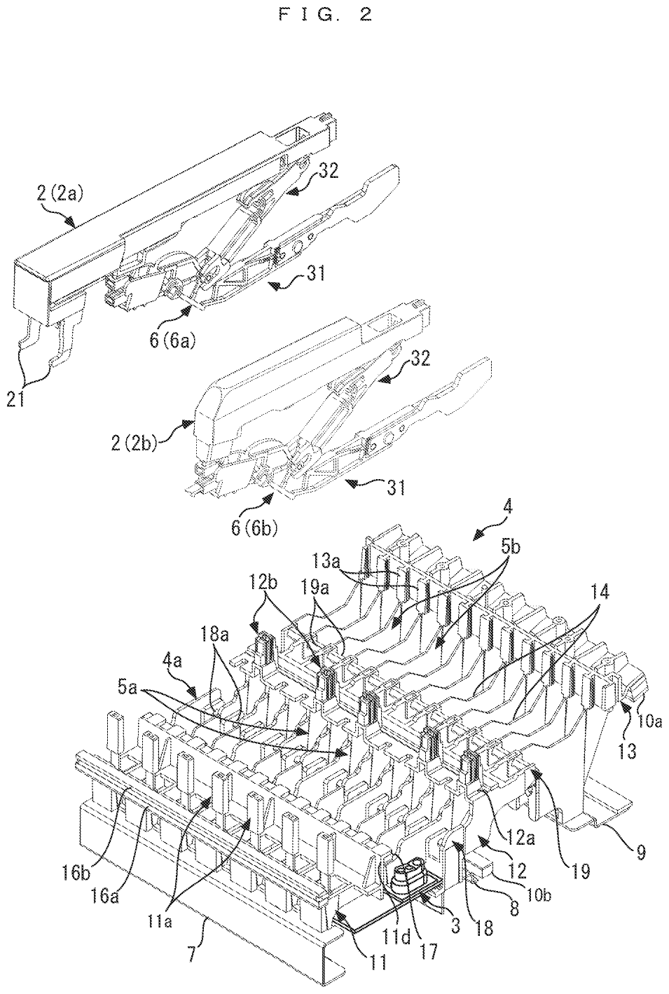

FIG. 1B shows a state of the keyboard device 1 shown in FIG. 1A, in which keys 2 other than a white key 2a and a black key 2b at a left end of the keyboard device 1 are omitted. FIG. 2 shows a state of the keyboard device 1 shown in FIG. 1B, in which the white key 2a and the black key 2b are removed, together with respective key support mechanisms 6 therefor, from a keyboard chassis 4.

This keyboard device 1 is comprised of the keyboard chassis 4, the plurality of keys 2 including the white keys 2a and the black keys 2b and arranged in a state arranged side by side in a left-right direction, the plurality of key support mechanisms 6 each pivotally mounted on the keyboard chassis 4, for supporting an associated one of the keys 2 from below, and key switches 3 each for detecting key depression information of an associated one of the keys 2.

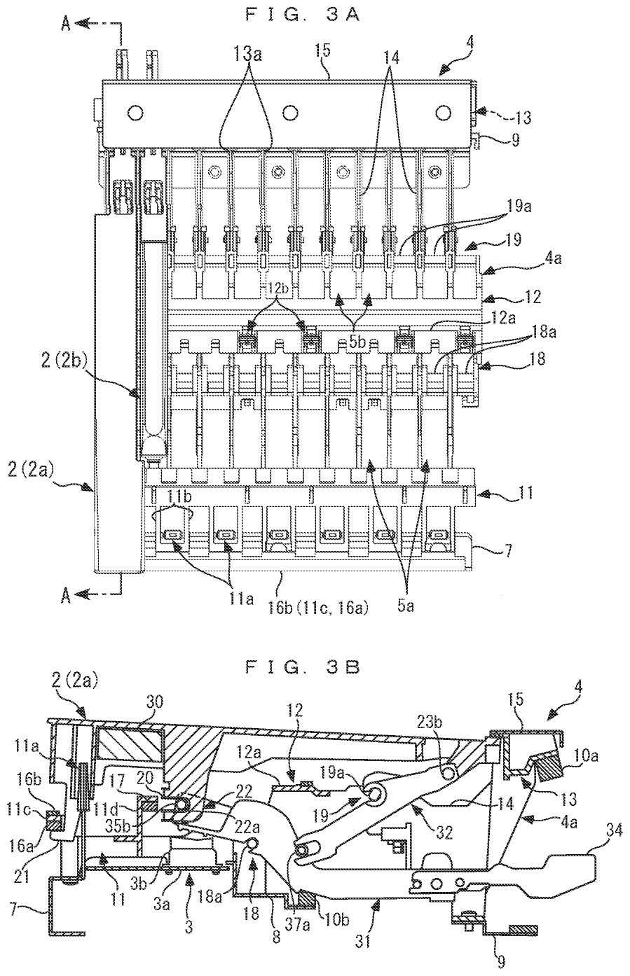

The keyboard chassis 4 includes a chassis body 4a formed as a resin molded article which is made e.g. by injection molding of a predetermined resin material (e.g. an ABS resin) into a predetermined shape. As shown in FIGS. 3A and 3B, the chassis body 4a has a front portion 11, an intermediate portion 12, and a rear portion 13, each extending in the left-right direction (in a left-right direction as viewed in FIG. 3A) as a whole. The front portion 11, the intermediate portion 12, and the rear portion 13 are integrally formed with each other via a plurality of ribs 14 disposed with a spacing therebetween in the left-right direction and each extending in the front-rear direction. Note that in the following description, the front portion 11, the intermediate portion 12, and the rear portion 13 of the chassis body 4a of the keyboard chassis 4 will be referred to as “the chassis front 11”, “the chassis intermediate 12”, and “the chassis rear 13”, respectively.

The chassis front 11 is mainly for guiding the white key 2a during depression thereof and restricting the upper limit position and the lower limit position of a front end of the white key 2a. On the chassis front 11, there are erected a plurality of white key guides 11a, each of which is inserted into each associated one of the white keys 2a from below so as to prevent lateral swing of the white key 2a, in a state arranged side by side in the left-right direction. Further, the chassis front 11 has engagement holes 11b and 11b, vertically extending therethrough, which are formed on the left and right sides of each of the white key guides 11a, respectively. A pair of left and right upper limit position regulation portions 21 and 21, referred to hereinafter, of the white key 2a are engaged with the respective engagement holes 11b and 11b in a state inserted therethrough. Furthermore, the chassis front 11 has a front end thereof formed with a stopper-mounting portion 11c that protrudes forward and extends along the entirety of the chassis body 4a in the left-right direction. A key upper limit stopper 16a and a key lower limit stopper 16b for the white key are mounted on a lower surface and an upper surface of the stopper-mounting portion 11c, respectively, such that they extend in the left-right direction. Note that a stopper-mounting portion 11d for the black key, which extends along the entirety of the chassis body 4a in the left-right direction, is provided at a predetermined location of the chassis front 11, rearward of each white key guide 11a, and that a key upper limit stopper 17 for the black key is mounted on the stopper-mounting portion 11d such that it extends in the left-right direction.

The chassis intermediate 12 is mainly for guiding the black key 2b during depression thereof and swingably supporting a first arm 31 and a second arm 32, described hereinafter, of each of a white key-associated key support mechanism 6a and a black key-associated key support mechanism 6b. The chassis intermediate 12 has a flat portion 12a in the form of a flat plate extending in the left-right direction, and a plurality of black key guides 12b erected on the flat portion 12a and disposed with an appropriate spacing therebetween in the left-right direction. Each black key guide 12b is inserted into an associated one of the black keys 2b from below to prevent lateral swing of the black key 2b. Further, the chassis intermediate 12 has a front portion thereof provided with a first arm support portion 18 for supporting the first arms 31 of the key support mechanisms 6. The first arm support portion 18 has a plurality of first pivot shafts 18a each of which is provided between each adjacent two of the ribs 14 and 14 such that the first pivot shaft 18a extends in the left-right direction. The first arms 31 are swingably supported on associated ones of the first pivot shafts 18a. Furthermore, the chassis intermediate 12 has a rear portion thereof provided with a second arm support portion 19 for supporting the second arms 32 of the key support mechanisms 6. The second arm support portion 19 has a plurality of second pivot shafts 19a each of which is provided between each adjacent two of the ribs 14 and 14 such that the second pivot shaft 19a extends in the left-right direction. The plurality of second pivot shafts 19a are arranged on the same axis extending in the left-right direction at a location rearward of and higher than the first pivot shafts 18a, and the second arms 32 are swingably supported on associated ones of the second pivot shafts 19a. Note that a first arm lower limit stopper 10b extending along the entirety of the chassis body 4a in the left-right direction is provided at a predetermined location of a middle rail 8, referred to hereinafter, disposed below the chassis intermediate 12.

Further, the above-mentioned key switches 3 are provided on a lower portion of the keyboard chassis 4 between the above-described chassis front 11 and chassis intermediate 12. The key switches 3 are formed by a laterally elongated printed circuit board 3a extending in the left-right direction, and a plurality of switch bodies 3b formed by rubber switches attached to the printed circuit board 3a on a key-by-key basis, for being pressed by associated ones of the first arms 31 upon key depression.

The chassis rear 13 is mainly for guiding the keys 2 by their rear ends in the vertical direction while preventing lateral swing of the keys 2 and for restricting the upper limit positions of the rear ends of associated ones of the first arms 31. As shown in FIGS. 2 and 3A, the chassis rear 13 has a plurality of partition walls 13a formed with a predetermined spacing therebetween in the left-right direction so as to separate each adjacent two of the keys 2 and 2 from each other. Further, as shown in FIG. 3B, a first arm upper limit stopper 10a extending along the entirety of the chassis body 4a in the left-right direction is provided at a predetermined location of an upper portion of the chassis rear 13. The first arm upper limit stopper 10a and the above-mentioned first arm lower limit stopper 10b provided on the chassis intermediate 12 are for restricting the upper limit position and the lower limit position of the first arm 31, respectively, when the first arm 31 having a function as a hammer for adding a touch weight to the key 2 pivotally moves upward and downward. Furthermore, a metal cover plate 15 extending in the left-right direction along the entirety of the chassis body 4a and disposed to cover the rear ends of the keys 2 is mounted on the upper portion of the chassis rear 13.

As shown in FIGS. 2 and 3A, the chassis body 4a of the keyboard chassis 4 constructed as described above is formed with a plurality of first openings 5a open upward and forward and a plurality of second openings 5b open upward. The first arms 31 of the key support mechanisms 6 are engaged with associated ones of the first pivot shafts 18a from outside via the above-mentioned first openings 5a, respectively. Further, the second arms 32 are engaged with associated ones of the second pivot shafts 19a from outside via the above-mentioned second openings 5b, respectively.

Further, in the above-described keyboard chassis 4, a plurality of chassis bodies 4a are connected to each other so as to be arranged side by side in the left-right direction, and are each screwed to a front rail 7, the middle rail 8, and a rear rail 9 in a state placed thereon, the rails 7, 8 and 9 each extending in the left-right direction and arranged with a predetermined spacing therebetween in the front-rear direction. The keyboard chassis 4 is fixed to a keybed, not shown, of the electronic piano via the front rail 7 and the rear rail 9.

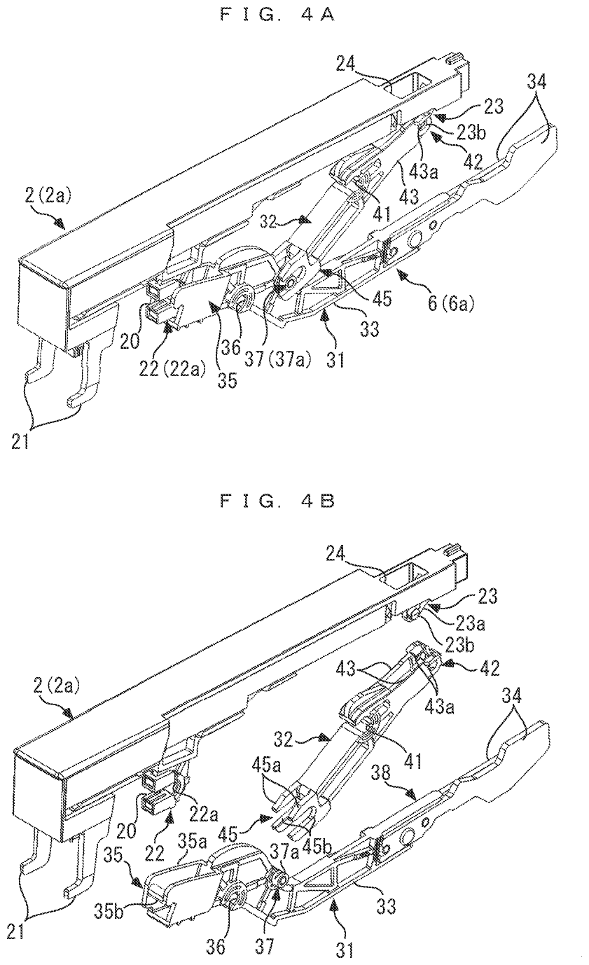

Next, the keys 2 and the key support mechanisms 6 will be described. FIG. 4A shows the white key 2a and the key support mechanism 6a therefor on an enlarged scale, and FIG. 4B shows them in an exploded state. As shown in FIGS. 4A and 4B, the white key 2a is formed e.g. by injection molding of a predetermined resin material (e.g. an AS resin) into a hollow shape which extends a predetermined length in the front-rear direction and opens downward. The white key 2a has the front end thereof formed with the pair of left and right upper limit position regulation portions 21 and 21 which protrude downward from respective side walls of the front end of the white key 2a and each having a lower end thereof bent forward. As described hereinabove, the left and right upper limit position regulation portions 21 and 21 are engaged with the respective left and right engagement holes 11b and 11b of the chassis front 11 in a state inserted therethrough.

Further, at a predetermined location of a front portion of the white key 2a, rearward of the upper limit position regulation portions 21, there is formed a key front-side connecting portion 22 connected to the first arm 31 of the key support mechanism 6a. This key front-side connecting portion 22 includes a connecting recess 22a formed into a U shape having a slot-like shape in side view and open forward. Further, the connecting recess 22a has a cushioning member 20 attached thereto, which is formed to cover the whole inner peripheral surface of the connecting recess 22a, for suppressing generation of noise when a connecting shaft 35b, referred to hereinafter, of the first arm 31 slides in the inner peripheral surface of the connecting recess 22a. Note that in the front portion of the white key 2a, between the above-described upper limit position regulation portions 21 and key front-side connecting portion 22, there is mounted a keyboard-associated weight 30 (see FIG. 3B) for adding a desired touch weight to the white key 2a during depression thereof.

Furthermore, the white key 2a has a rear portion thereof provided with a key rear-side connecting portion 23 connected to the second arm 32 of the key support mechanism 6a. The key rear-side connecting portion 23 has a plate-like connecting body portion 23a which hangs downward from a laterally central portion of the white key 2a and has a predetermined thickness in the left-right direction, and a pair of left and right engagement protrusions 23b and 23b which coaxially protrude from the left and right side surfaces of the connecting body portion 23a, respectively. Further, the rear portion of the white key 2a is formed with a tool insertion hole 24 which vertically extends through the rear portion, and is used to insert a predetermined tool from above for disconnecting the white key 2a from the second arm 32 of the key support mechanism 6a e.g. for maintenance of the keyboard device 1.

On the other hand, the key support mechanism 6a includes the first arm 31 and the second arm 32 which are engaged with each other and are connected to the key front-side connecting portion 22 and the key rear-side connecting portion 23 of the white key 2a, respectively.

As shown in FIG. 4B, the first arm 31 is comprised of an arm body 33 and two weights 34 and 34 attached to the arm body 33. The arm body 33 is formed as a resin molded article which is made e.g. by injection molding of a predetermined resin material (e.g. polyacetal resin) into a predetermined shape. This arm body 33 extends a predetermined length in the front-rear direction, and has a front end thereof formed with a first arm front-side connecting portion 35 connected to the key front-side connecting portion 22 of the white key 2a. The first arm front-side connecting portion 35 includes a box portion 35a having a box-like shape open upward and forward, and the connecting shaft 35b provided such that it extends in the left-right direction in a state connecting the front-side upper ends of left and right side walls of the box portion 35a to each other. The connecting shaft 35b is connected to the connecting recess 22a of the key front-side connecting portion 22 of the white key 2a such that the connecting shaft 35b is pivotally movable and is slidable in the front-rear direction.

Further, the arm body 33 has a bearing portion 36 formed at a predetermined location immediately rearward of the first arm front-side connecting portion 35. The bearing portion 36 has an inverted U shape open downward in side view, and is pivotally engaged with the first pivot shaft 18a of the keyboard chassis 4. Furthermore, the arm body 33 has a first arm rear-side connecting portion 37, which is connected to the second arm 32, at a predetermined location rearward of the bearing portion 36. Specifically, the first arm rear-side connecting portion 37 has a connecting shaft 37a which extends in the left-right direction with respective opposite ends thereof protruding outward from the left and right side surfaces of the arm body 33. The opposite ends of the connecting shaft 37a are engaged with connecting recesses 45b and 45b of a second arm front-side connecting portion 45, referred to hereinafter, of the second arm 32.

The two weights 34 and 34 formed as elongated and narrow plates are mounted on a weight mounting portion 38, which is a rear portion of the arm body 33, in a state sandwiching the weight mounting portion 38. Note that each weight 34 is made of a material (metal such as iron) having a larger specific gravity than the arm body 33, and is formed e.g. by pressing a metal plate into a predetermined shape.

The second arm 32 is formed as a resin molded article having a predetermined shape by injection molding of the same resin material as that of the arm body 33 of the first arm 31. The second arm 32 is shorter than the first arm 31 and extends a predetermined length in the front-rear direction. Further, the second arm 32 has a bearing portion 41 having a C shape open forward in side view approximately at a longitudinal center thereof. The bearing portion 41 is pivotally engaged with an associated one of the second pivot shafts 19a of the keyboard chassis 4.

Further, the second arm 32 has a rear portion thereof provided with a second arm rear-side connecting portion 42 connected to the key rear-side connecting portion 23 of the white key 2a. The second arm rear-side connecting portion 42 is formed into a bifurcated shape, and has two left and right connecting arm portions 43 and 43 which extend a predetermined length parallel to each other along the longitudinal direction of the second arm 32. Each connecting arm portion 43 has a rear end thereof formed with a connecting hole 43a extending through the connecting arm portion 43 in the left-right direction. The two connecting arm portions 43 and 43 sandwich the connecting body portion 23a of the key rear-side connecting portion 23 of the white key 2a between the rear ends thereof from the left and the right, and each connecting hole 43a has an associated one of the engagement protrusions 23b of the key rear-side connecting portion 23 pivotally fitted therein.

Furthermore, the second arm 32 has a front portion thereof provided with the second arm front-side connecting portion 45 connected to the first arm rear-side connecting portion 37 of the first arm 31. The second arm front-side connecting portion 45 has a pair of left and right connecting portions 45a and 45a arranged with a predetermined spacing in the left-right direction. The connecting portions 45a and 45a are each formed with the connecting recess 45b which has a U shape having a slot-like shape in side view and open forward. The left and right connecting portions 45a and 45a of the second arm front-side connecting portion 45 are pivotally and slidably engaged with the respective opposite ends of the connecting shaft 37a of the first arm 31 via the connecting recesses 45b and 45b thereof.

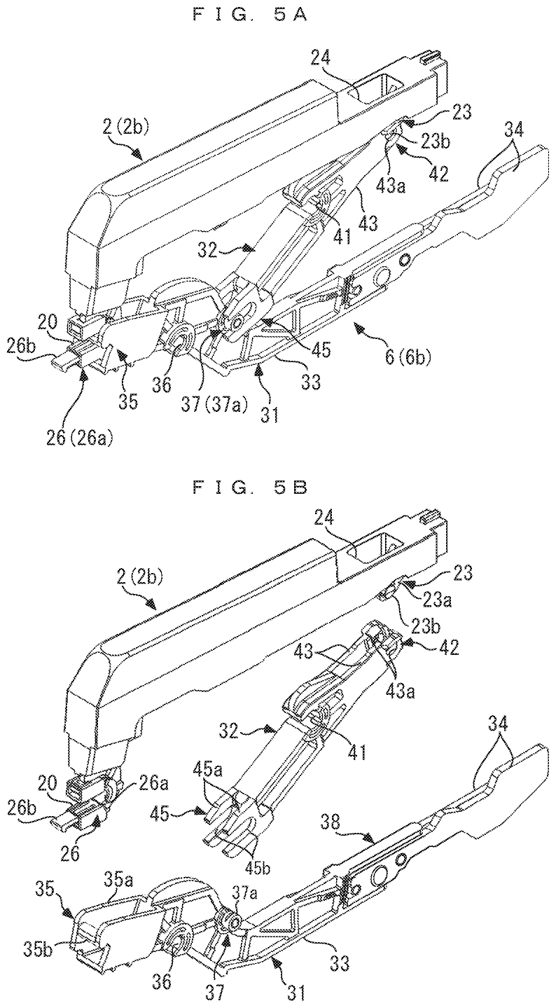

FIG. 5A shows the black key 2b and the key support mechanism 6b therefor on an enlarged scale, and FIG. 5B shows the black key 2b and the key support mechanism 6b in an exploded state. The black key 2b is formed e.g. by injection molding of the same resin material as that of the white key 2a into a hollow shape which extends in the front-rear direction by a predetermined length shorter than that of the white key 2a and opens downward. The black key 2b has a front-side lower end thereof provided with a key front-side connecting portion 26 formed substantially similar to the key front-side connecting portion 22 of the white key 2a. This key front-side connecting portion 26 has a connecting recess 26a formed into a U shape having a slot-like shape in side view and open forward. Further, the key front-side connecting portion 26 has an extension portion 26b on a lower-side front end of the connecting recess 26a. The extension portion 26b extends a predetermined length forward of the front surface of the body of the black key 2b. This extension portion 26b functions as an upper limit position regulation portion of the black key 2b. Note that in the following description, the components of the black key 2b and the key support mechanism 6b having the same configurations as those of the above-described white key 2a and key support mechanism 6a are denoted by the same reference numerals and detailed description thereof will be omitted.

The key support mechanism 6b supporting the black key 2b is constructed substantially similar to the above-described white key-associated key support mechanism 6a. Specifically, the arm body 33 of the first arm 31 of the key support mechanism 6b and the second arm 32 of the same are constructed exactly similar in shape and size to the arm body 33 and the second arm 32 of the white key-associated key support mechanism 6a. Note that although as the two left and right weights 34 and 34 of the key support mechanism 6b for the black key 2b, the same weights as the weights 34 and 34 of the key support mechanism 6a for the white key 2a are shown in FIGS. 5A and 5B, the shapes and lengths of the weights 34 and 34 of the key support mechanisms 6b are appropriately changed according to touch weights required for the keys 2 or the like.

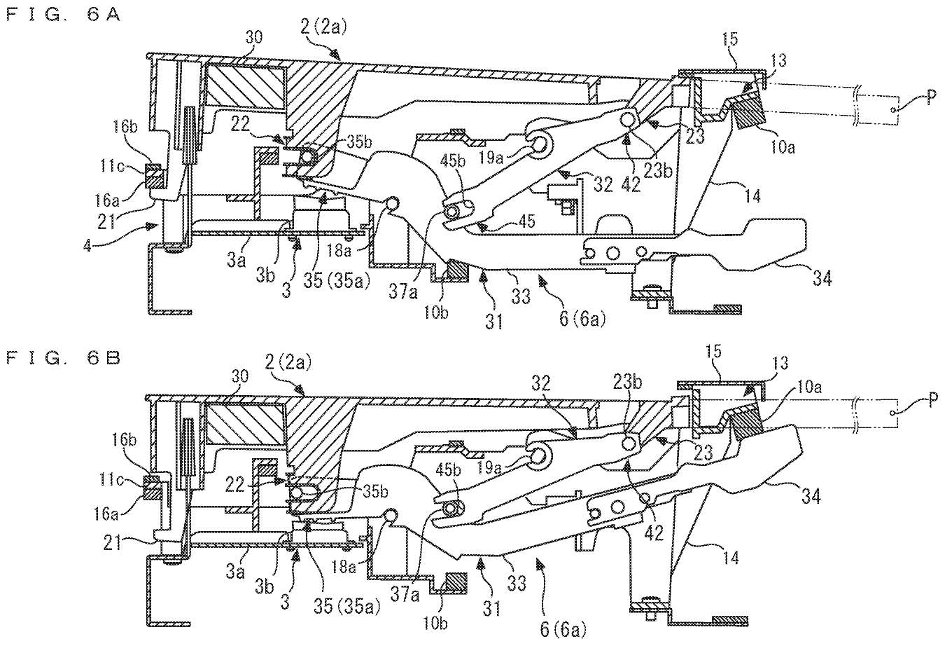

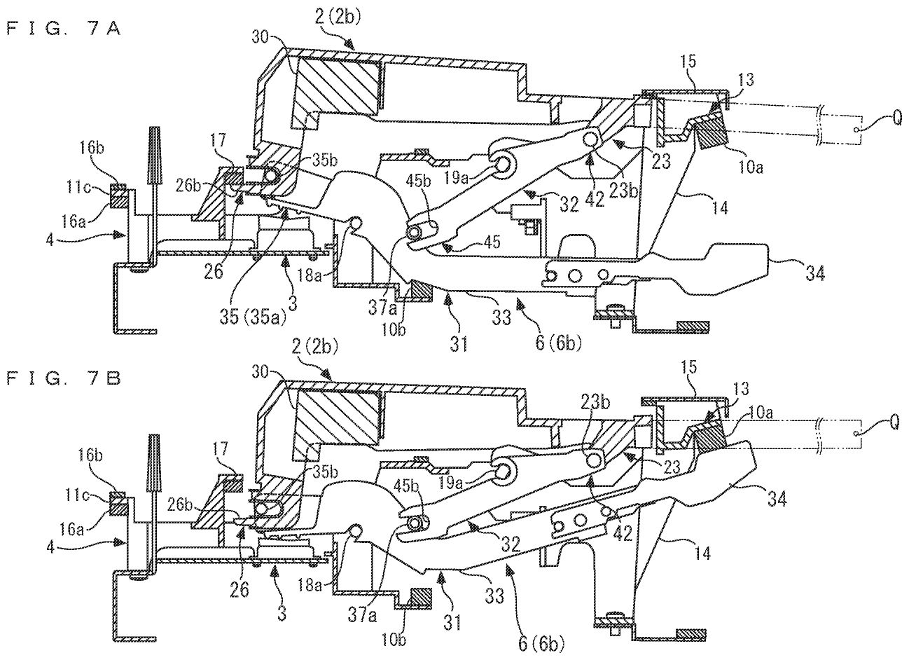

Next, a description will be given of the operation of the keys 2 and the key support mechanisms 6 of the keyboard device 1 constructed as described above. FIGS. 6A and 6B are views useful in explaining the operation of the white key 2a and the key support mechanism 6a associated therewith. FIGS. 7A and 7B are views useful in explaining the operation of the black key 2b and the key support mechanism 6b associated therewith.

When the front end of the white key 2a is depressed by a player with his/her finger from a key-released state shown in FIG. 6A, the key front-side connecting portion 22 of the white key 2a is moved downward, whereby the first arm 31 is pivotally moved in a counterclockwise direction about the first pivot shaft 18a. Further, in accordance with the pivotal movement of the first arm 31, the second arm front-side connecting portion 45, which is engaged with the connecting shaft 37a of the first arm 31 via the connecting recesses 45b and 45b, is moved upward. With this, the second arm 32 is pivotally moved in a clockwise direction about the second pivot shaft 19a. Then, in accordance with this pivotal movement of the second arm 32, the key rear-side connecting portion 23, which is connected to the second arm 32 via the second arm rear-side connecting portion 42 formed at the rear end of the second arm 32, is pulled down, whereby the rear end of the white key 2a is moved downward.

Note that during the above-mentioned pivotal movement of the first arm 31, the box portion 35a of the first arm front-side connecting portion 35 is moved downward, and accordingly, the switch body 3b of one of the key switches 3, which is associated with the depressed key 2, is pressed from above by the bottom wall of the box portion 35a. As a consequence, in the electronic piano, key depression information of the depressed key 2 is detected, and based on the detected key depression information, sound is generated from a speaker, not shown.

As described hereinabove, in the case where the white key 2a is depressed, in accordance with the counterclockwise pivotal movement of the first arm 31, the weight 34 of the first arm 31 is inclined such that the weight 34 becomes higher as it extends rearward, whereby the rear end of the weight 34 moves into contact with the first arm upper limit stopper 10a from below, as shown in FIG. 6B. This prevents further pivotal movement of the first arm 31. When the front end of the white key 2a is depressed to its lowest position, the front end of the white key 2a is brought into contact with the key lower limit stopper 16b, which blocks further depression of the white key 2a.

The white key 2a depressed as above operates such that it pivotally moves about a virtual pivot P located rearward of the rear end thereof. The location of the virtual pivot P is set such that a distance from the front end of the white key 2a is approximately twice as long as the length of the white key 2a itself, for example. With this, when the front end of the white key 2a is depressed to the lowest position, compared with the case where the white key 2a is in the key-released state shown in FIG. 6A, the front end of the white key 2a is positioned lower by a predetermined key stroke (e.g. 10 mm) and the rear end of the white key 2a is located lower by a distance (e.g. 5 mm) which is approximately half of the predetermined key stroke.

On the other hand, when the finger is released from the white key 2a having been depressed, the first arm 31 of the key support mechanism 6a pivotally moves in a direction opposite to the above-mentioned direction, by the own weight of the weight 34, and in accordance therewith, the second arm 32 as well pivotally moves in a direction opposite to the above-mentioned direction. In accordance with this pivotal movement of the second arm 32, the white key 2a pivotally moves upward about the virtual pivot P. Then, a predetermined portion of the first arm 31, rearward of the first pivot shaft 18a, moves into contact with the first arm lower limit stopper 10b from above, and both of the upper limit position regulation portions 21 and 21 of the white key 2a move into contact with the key upper limit stopper 16a from below, whereby further pivotal movement of the white key 2a is blocked and the white key 2a returns to its original key-released state.

Further, when the black key 2b is depressed, operations are performed similar to the above-described operations of the white key 2a and the key support mechanism 6a. More specifically, when a front end of the black key 2b is depressed from a key-released state shown in FIG. 7A, the first arm 31 is pivotally moved in the counterclockwise direction about the first pivot shaft 18a, and the second arm 32 is pivotally moved in the clockwise direction about the second pivot shaft 19a. With this, the black key 2b is operated such that it is pivotally moved about a virtual pivot Q located rearward of the rear end thereof. Note that similar to the above-mentioned virtual pivot P of the white key 2a, the location of the virtual pivot Q is set such that a distance from the front end of the black key 2b is approximately twice as long as the length of the black key 2b itself, for example. Therefore, when the front end of the black key 2b is depressed to its lowest position, compared with a case where the black key 2b is in the key-released state shown in FIG. 7A, the front end of the black key 2b is positioned lower by a predetermined key stroke and the rear end thereof is positioned lower by a distance which is approximately half of the predetermined key stroke.

On the other hand, when the finger is released from the black key 2b having been depressed, the first arm 31 and the second arm 32 of the key support mechanism 6b pivotally move in respective directions opposite to the above-mentioned directions, and in accordance therewith, the black key 2b pivotally moves upward about the virtual pivot Q. Then, the extension portion 26b of the key front-side connecting portion 26 of the black key 2b moves into contact with the key upper limit stopper 17 from below, whereby further pivotal movement of the black key 2b is blocked, and the black key 2b returns to its original key-released state.

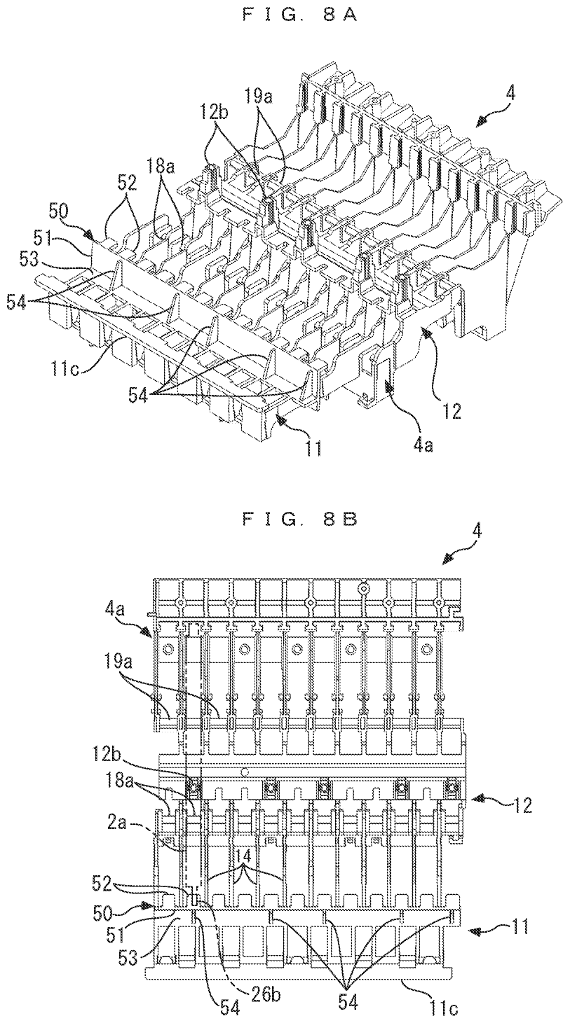

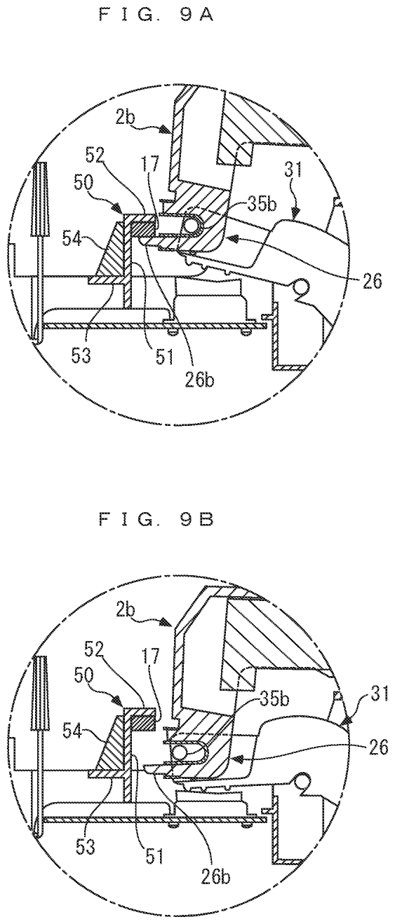

Next, the essential part of the present invention will be described with reference to FIGS. 8A and 8B and FIGS. 9A and 9B. The essential part of the present invention consists in that the chassis body 4a of the keyboard chassis 4 includes a plurality of reinforcement ribs 54 (ribs) provided on a stopper support portion 50 that supports the key upper limit stopper 17 for the black keys 2b.

As shown in FIGS. 8A and 8B, the stopper support portion 50 for supporting the key upper limit stopper 17 (stopper, see e.g. FIG. 2) for the black keys 2b is provided on the chassis front 11 of the chassis body 4a. The stopper support portion 50 includes an erected wall 51 (erected portion) extending in the left-right direction along the entirety of the black keys 2b in a state erected forward of all the black keys 2b, a plurality of (twelve in FIGS. 8A and 8B) mounting portions 52 (stopper mounting portions) protruding rearward from an upper end of the erected wall 51, for having the key upper limit stopper 17 for the black keys 2b mounted thereon, and a horizontally protruding portion 53 horizontally protruding forward from a lower portion of the erected wall 51 and extending in the left-right direction along the entirety of the erected wall 51.

The above-described erected wall 51, mounting portions 52, and horizontally protruding portion 53 are each formed in a plate shape having a predetermined thickness. Further, the mounting portions 52 are associated with the respective keys 2 and are disposed with a spacing therebetween in the left-right direction. More specifically, as shown in FIG. 8B, each mounting portion 52 is disposed such that it is disposed between laterally adjacent ones of the ribs 14 and 14 that connect the chassis front 11 and the chassis intermediate 12 in the front-rear direction. Further, as shown in FIGS. 9A and 9B, the key upper limit stopper 17 for the black keys 2b, which extends in the left-right direction, is mounted on the lower surfaces of the mounting portions 52 by bonding.

As shown in FIG. 8A, the stopper support portion 50 is provided with the plurality of (five in FIGS. 8A and 8B) reinforcement ribs 54. Each reinforcement rib 54 is formed in a plate shape of a substantially right triangle in side view with a predetermined thickness, and is provided at a corner between the erected wall 51 and the horizontally protruding portion 53 in a state continuous with a front surface of the erected wall 51 and an upper surface of the horizontally protruding portion 53. Further, each reinforcement rib 54 is formed at a location corresponding to an associated one of the black keys 2b.

FIGS. 9A and 9B are views corresponding to FIGS. 7A and 7B, respectively, and show the stopper support portion 50 and the reinforcement rib 54 in the center as well as components therearound, on an enlarged scale. FIG. 9A shows a key-released state in which the extension portion 26b (contact portion) of the black key 2b is in contact with the key upper limit stopper 17 from below. On the other hand, FIG. 9B shows a key-depressed state in which the extension portion 26b of the black key 2b is moved downward away from the key upper limit stopper 17 by depression of the black key 2b.

As described hereinabove, when the black key 2b is released from the depressed state, the black key 2b pivotally moves while being pushed up by the key support mechanism 6b, whereby the extension portion 26b of the black key 2b moves into contact with the key upper limit stopper 17 from below. With this, further pivotal movement of the black key 2b is blocked and the black key 2b returns to its original key-released state.

As described above in detail, according to the present embodiment, since the stopper support portion 50 of the chassis body 4a has the reinforcement ribs 54 provided therefor in association with the plurality of black keys 2b, respectively, a portion of the chassis body 4a, which is contacted by the extension portion 26b of each black key 2b via the key upper limit stopper 17, can be directly and efficiently reinforced. With this, it is possible to increase the rigidity of the portion of the chassis body 4a, which is liable to receive impact and vibration caused by release of the depressed black key 2b, while ensuring reduction of the weight of the keyboard chassis 4.

Further, since each reinforcement rib 54 is provided at the corner between the erected wall 51 and the horizontally protruding portion 53, this structure makes it possible to further increase the rigidity of the portion of the chassis body 4a where the reinforcement rib 54 is provided.

Furthermore, the key upper limit stopper 17 for the black keys 2b, which is supported by the stopper support portion 50, is securely mounted on the mounting portions 52. Further, compared with a case in which the mounting portions 52 are formed as a continuous member extend along the entirety of the chassis body 4a in the left-right direction, it is possible to reduce the amount of synthetic resin required for molding the chassis body 4a and relatively easily perform the molding thereof.

Note that the present invention is not limited to the above-described embodiment, but it can be practiced in various forms. For example, although in the present embodiment, the reinforcement ribs 54 are provided on the stopper support portion 50 of the chassis body 4a at respective locations corresponding to the black keys 2b, the present invention is not limited to this, but it is also possible to appropriately provide reinforcement ribs similar to the reinforcement ribs 54 on the chassis front 11 at respective locations corresponding to the white keys 2a.

Further, details of the constructions of the stopper support portion 50 and the reinforcement ribs 54 shown in the embodiment are given only by way of example, and they can be modified as appropriate within the scope of the subject matter of the present invention. For example, although in the present embodiment, the stopper support portion 50 is disposed forward of the black keys 2b, it is also possible to dispose a stopper support member below the keys 2. Further, although in the present embodiment, the reinforcement ribs 54 are erected on the front surface of the erected wall 51, it is also possible to erect the same reinforcement ribs on a rear surface of the erected wall 51.

It is further understood by those skilled in the art that the foregoing are preferred embodiments of the invention, and that various changes and modifications may be made without departing from the spirit and scope thereof.

What is claimed is:

1. A keyboard device for a keyboard instrument, comprising:
a keyboard chassis made of synthetic resin and having a stopper support portion that supports a stopper extending in a left-right direction; and
a plurality of keys each extending in a front-rear direction and configured such that each key is pivotally moved downward in accordance with depression of the key, and in accordance with release of the key having been depressed, pivotally moves upward into contact with the stopper from below via a contact portion protruding from a lower portion of a front end of the key in a front-rear direction, to thereby have upward pivotal movement of the key blocked, the plurality of keys being disposed on a top of the keyboard chassis in a side-by-side arrangement in the left-right direction,
wherein the stopper support portion includes:
a plate-like erected portion extending in the left-right direction along the entirety of the plurality of keys in a state erected at a location forward of or below the plurality of keys, and
a stopper mounting portion formed in a plate shape protruding from an upper end of the erected portion in the front-rear direction, and having the stopper mounted on a lower surface thereof, and
wherein the keyboard chassis further includes a plurality of plate-like ribs erected on a front surface or a rear surface of the erected portion, such that the ribs are associated with corresponding ones of the contact portions of the plurality of keys, respectively.

2. The keyboard device according to claim 1, wherein the stopper support portion further includes a horizontally protruding portion horizontally protruding from the front surface or the rear surface of the erected portion and extending in the left-right direction along the entirety of the erected portion, and
wherein each of the plurality of ribs is continuous with the erected portion and the horizontally protruding portion and is provided at a corner between the erected portion and the horizontally protruding portion.

3. The keyboard device according to claim 1, wherein the stopper mounting portion is formed by a plurality of stopper mounting portions which are associated with the plurality of keys, respectively, and are disposed with a spacing therebetween along a longitudinal direction of the erected portion.

4. The keyboard device according to claim 1, wherein the plurality of keys are formed by white keys and black keys, and
wherein each of the plurality of ribs is formed at a location corresponding to an associated one of the black keys.
